(19) United States
(12) Patent Application Publication
(10) Pub. No.: US 2012/0042494 A1
(43) Pub. Date: Feb. 23, 2012

(54) ROPE THIMBLE WITH CLOSED CURVE

(76) Inventor: James E. FAY, Boulder, CO (US)

(21) Appl. No.: 13/212,029

(22) Filed: Aug. 17, 2011

Related U.S. Application Data
(60) Provisional application No. 61/374,548, filed on Aug. 17, 2010.

(51) Int. Cl. F16G 11/12; B23P 11/00; B23P 15/00

(52) U.S. Cl. 29/428; 24/129 R; 29/592

(57) ABSTRACT

A rope thimble with a closed curve substantially reduces rope wear. Various closed curve rope thimbles may include side walls of different heights.

### CROSS-REFERENCE TO RELATED APPLICATION

This application claims the benefit of U.S. Provisional Patent Application Ser. No. 61/374,548, filed on Aug. 17, 2010, which is incorporated herein by reference in its entirety for all purposes.

### TECHNICAL FIELD

Embodiments of the present invention relate to rope thimbles, and more particularly to a rope thimble with a closed curve.

### BACKGROUND

Thimbles are commonly used to create loop end-terminations in ropes. The thimble shifts load and abrasion to the thimble instead of the rope. The thimble also increases the diameter of the bend in the rope termination which also strengthens the rope.

One problem with conventional rope thimbles is that they have two sharp ends. If the load on the end of the rope through the thimble is not exactly centered, one of the sharp ends of the thimble is forced into the rope and serves to cut the rope. In this manner, thimbles often decrease rope strength rather than increasing rope strength.

Another problem with conventional rope thimbles is that they are designed to be used with swaged or sewn loops at the end of the rope, rather than for use with rope end loops formed by tied knots.

Another problem with conventional rope thimbles is that, because they taper to two points, they are relatively flat and protect a relatively small portion of the diameter of the rope end.

### SUMMARY

Rope thimbles according to embodiments of the present invention protect and prevent damage from being done to a loop end termination in a rope.

A closed curve rope thimble according to one or more embodiments of the present invention solves one or more of these problems. The closed curve means there are no sharp edges to cut the rope. The closed curve is particularly suited for use with knotted loop rope ends. The closed curve makes it practical to form a deep groove in the rope thimble to protect a large part of the rope diameter.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a front view of a conventional thimble used with wire rope.

FIG. 2 illustrates a front view of a conventional thimble used with rope and a sewn eye.

FIG. 3 illustrates a front view of a closed curve rope thimble, according to embodiments of the present invention.

FIG. 4 illustrates a top view of the closed curve rope thimble of FIG. 3, according to embodiments of the present invention.

FIG. 5 illustrates a top view of an alternative closed curve rope thimble, according to embodiments of the present invention.

FIG. 6 illustrates a side perspective view of the closed curve rope thimble of FIGS. 3 and 4 with a rope in it, according to embodiments of the present invention.

FIG. 7 illustrates a front view of the closed curve rope thimble of FIGS. 3, 4, and 6 with a rope in it, according to embodiments of the present invention.

FIG. 8 illustrates a front view of the closed curve rope thimble of FIG. 5 with a rope in it, according to embodiments of the present invention.

FIG. 9 illustrates a side perspective view of the closed curve rope thimble of FIGS. 5 and 8 with a rope in it, according to embodiments of the present invention.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

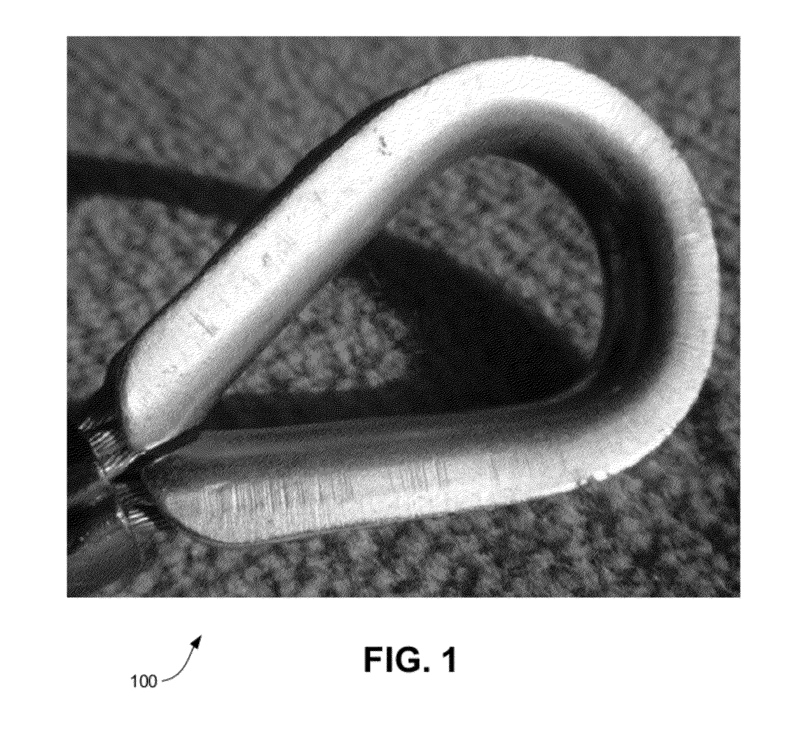

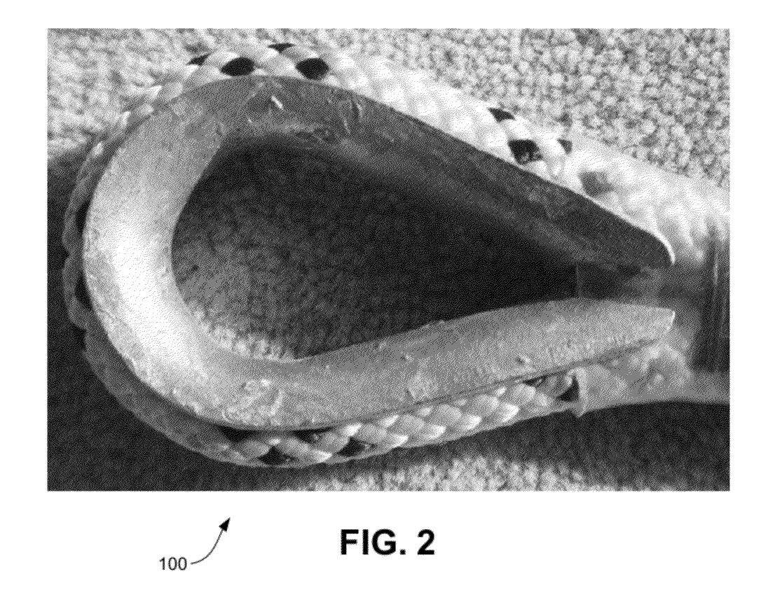

FIG. 1 illustrates a front view of a conventional thimble 100 used with wire rope, showing the shape of the thimble and the sharp ends of the thimble. FIG. 2 illustrates a front view of a conventional thimble 100 used with rope and a sewn eye. The sharp ends of the thimble 100 can cut the rope if the load on the thimble 100 is not along the exact curved end of the thimble.

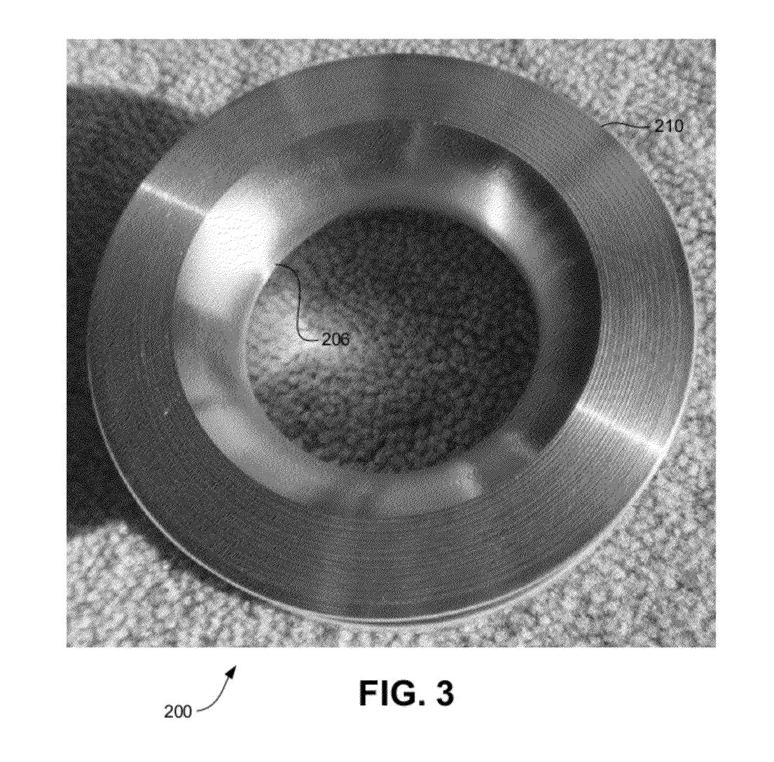

FIG. 3 illustrates a front view of a closed curve rope thimble 200, according to embodiments of the present invention. Thimble 200 lacks any sharp ends that might cut the rope. Although FIG. 3 illustrates a continuous circular closed curve, other closed curve shapes may be used in a similar manner, for example a closed oval shape.

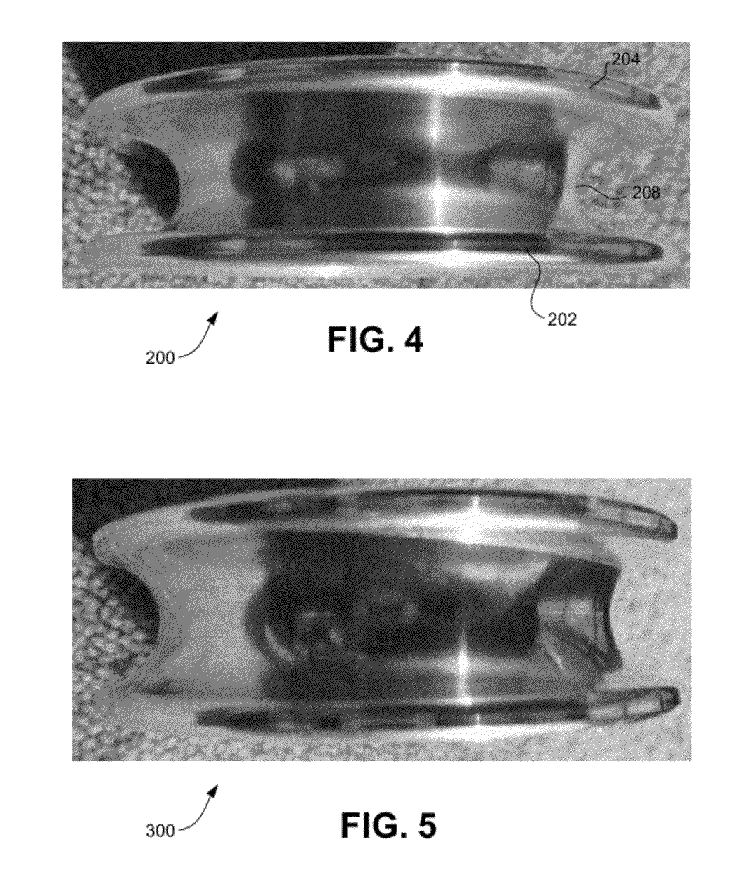

FIG. 4 illustrates a top view of the closed curve rope thimble 200 of FIG. 3, according to embodiments of the present invention. The thimble 200 may include a center groove that is deeper than those of conventional thimbles to completely protect the rope on three sides. This may be accomplished by, for example, making the side walls higher, according to embodiments of the present invention. This may also be accomplished by decreasing the radius of curvature of the central groove, and/or by both making the side walls higher and decreasing the radius of curvature of the central groove, according to embodiments of the present invention.

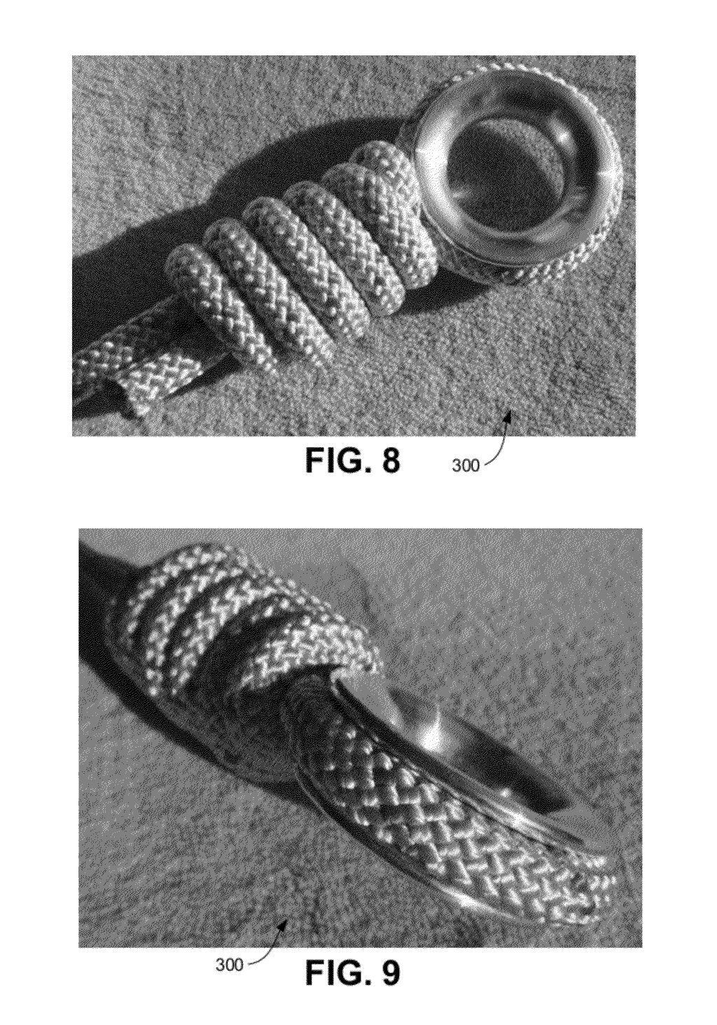

FIG. 5 illustrates a top view of an alternative closed curve rope thimble 300, according to embodiments of the present invention. Thimble 300 has a lower profile which, as illustrated in FIGS. 8 and 9, does not completely cover the rope on the sides.

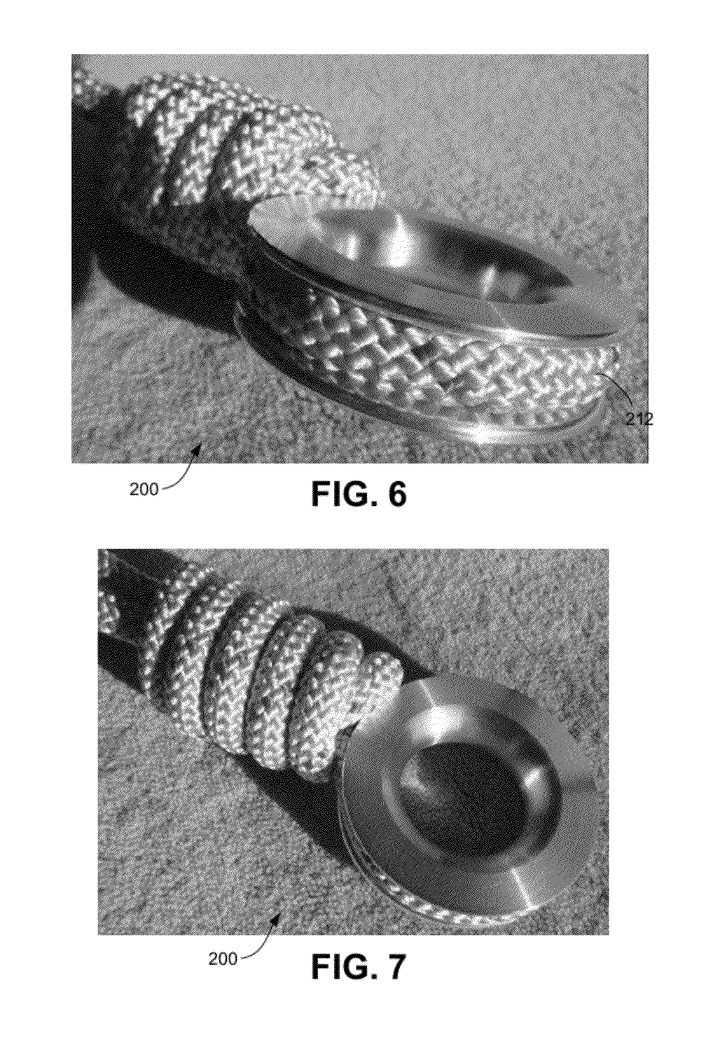

FIG. 6 illustrates a side perspective view of the closed curve rope thimble 200 of FIGS. 3 and 4 with a rope in it, according to embodiments of the present invention. The loop in the rope end is tied with a barrel knot, though one of ordinary skill in the art, based on the present disclosure, will appreciate that many different types of knots can be used to tie loops in rope ends.

FIG. 7 illustrates a front view of the closed curve rope thimble 200 of FIGS. 3, 4, and 6 with a rope in it, according to embodiments of the present invention. The thimble 200 is deep enough to protect the entire rope loop, which is often not possible with a conventional thimble, according to embodiments of the present invention.

FIG. 8 illustrates a front view of the closed curve rope thimble 300 of FIG. 5 with a rope in it, according to embodiments of the present invention. Thimble 300 has a lower profile and does not completely cover the sides of the rope around the loop portion. FIG. 9 illustrates a side perspective view of the closed curve rope thimble 300 of FIGS. 5 and 8 with a rope in it, according to embodiments of the present invention.

According to some embodiments of the present invention, the rope thimbles 200, 300 may be made of steel, stainless steel, aluminum, and/or titanium. Metals with beneficial thermal properties may be used, to prevent and/or minimize wear on the rope or other element passing through the “eye” of the thimble 200, 300, according to embodiments of the present invention. According to other embodiments of the present invention, thimbles 200, 300 may be made of plastic or hard rubber.

According to some embodiments of the present invention, the rope thimbles 200, 300 break under approximately thirteen thousand pounds of tensile force, while rope with a diameter of eleven or twelve millimeters breaks under approximately seven to eight thousand pounds of tensile force. As such, the rope thimble 200, 300 may be used as part of what is known to one of ordinary skill in the art as a “Y-rig.” For example, carabiners may be attached directly to the rope thimble 200, 300 in forming a climbing rig. The rope may be attached to the outer perimeter rope groove, and a carabiner clipped on through the central circular aperture.

FIGS. 3, 4, and 6 illustrate a rope system including a rope thimble 200, a circular aperture 206 formed through a center of the rope thimble 200, a rope groove 208 surrounding an outer perimeter 210 of the rope thimble 200, the rope groove 208 configured to accept a rope 212, wherein the rope groove 208 has a first side wall 202 and a second side wall 204, and wherein at least one of the first side wall 202 and the second side wall 204 protrude to or beyond an outer extent of the rope 212 when the rope 212 is seated within the rope groove 208.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A rope system comprising:
a rope thimble;
a circular aperture formed through a center of the rope thimble; and
a rope groove surrounding an outer perimeter of the rope thimble, the rope groove configured to accept a rope, wherein the rope groove has a first side wall and a second side wall, and wherein at least one of the first side wall and the second side wall protrude to or beyond an outer extent of the rope when the rope is seated within the rope groove.

2. The rope system of claim 1, wherein the outer perimeter is circular.

3. The rope system of claim 1, wherein both the first side wall and the second side wall protrude to or beyond the outer extent of the rope when the rope is seated within the rope groove.

4. The rope system of claim 3, further comprising the rope, wherein the rope groove comprises a continuous inner diameter configured to match a diameter of the rope.

5. The rope system of claim 3, wherein both the first side wall and the second side wall protrude beyond the outer extent of the rope when the rope is seated within the rope groove.

6. The rope system of claim 1, wherein the inner surface of the circular aperture is continuously beveled and smoothed.

7. The rope system of claim 1, wherein an inner surface of the rope groove configured to abut the rope is continuously curved and smooth.

8. The rope system of claim 1, further comprising a carabiner attached to the rope thimble through the circular aperture.

9. The rope system of claim 1, wherein the rope thimble is part of a Y-rig.

10. The rope system of claim 1, wherein the rope thimble is capable of withstanding a tensile force of thirteen thousand pounds.

11. A method for making a rope system, comprising:
forming a rope thimble;
forming a circular aperture through a center of the rope thimble; and
forming a rope groove surrounding an outer perimeter of the rope thimble, the rope groove configured to accept a rope, wherein the rope groove has a first side wall and a second side wall, and wherein at least one of the first side wall and the second side wall protrude to or beyond an outer extent of the rope when the rope is seated within the rope groove.

12. The method of claim 11, further comprising forming the outer perimeter to be substantially circular.

13. The method of claim 11, further comprising forming both the first side wall and the second side wall to protrude to or beyond the outer extent of the rope when the rope is seated within the rope groove.

14. The method claim 13, further comprising seating a rope within the rope groove, wherein the rope groove comprises a continuous inner diameter configured to match a diameter of the rope.

15. The method of claim 13, further comprising forming both the first side wall and the second side wall to protrude beyond the outer extent of the rope when the rope is seated within the rope groove.

16. The method of claim 11, further comprising forming the inner surface of the circular aperture as continuously beveled and smoothed.

17. The method of claim 11, further comprising forming an inner surface of the rope groove as continuously curved and smooth.

18. The method of claim 11, further comprising attaching a carabiner to the rope thimble through the circular aperture.

19. The method of claim 11, further comprising incorporating the rope thimble as part of a Y-rig.

20. A circular, closed curve rope thimble having a circular aperture formed through its center and a rope groove formed about its perimeter, the circular aperture and the rope groove both being continuously curved and smooth on their inner surfaces, the rope groove having a pair of side walls that protrude beyond an outer extent of a rope when the rope is seated within the rope groove.
